(19) United States
(12) Patent Application Publication
(10) Pub. No.: US 2013/0264983 A1
(43) Pub. Date: Oct. 10, 2013

(54) MOTOR CONTROLLING APPARATUS

(71) Applicant: CANON KABUSHIKI KAISHA, Tokyo (JP)

(72) Inventor: Yasuhiko Okumura, Tokyo (JP)

(73) Assignee: Canon Kabushiki Kaisha, Tokyo (JP)

(21) Appl. No.: 13/852,490

(22) Filed: Mar. 28, 2013

(30) Foreign Application Priority Data
Apr. 5, 2012 (JP) 2012-086522

(51) Int. Cl. H02P 23/00

(52) U.S. Cl. CPC H02P 23/0045
USPC 318/400.26

(57) ABSTRACT

A motor controlling apparatus, including: a detector configured to detect a rotation speed of a rotary member rotated by a motor; a first determining portion configured to determine a first control value based on a difference between a target speed and the rotation speed; a second determining portion configured to determine a second control value based on an amount of change in the first control value; and a motor controlling portion configured to control the motor based on the second control value.

### BACKGROUND OF THE INVENTION

1. Field of the Invention

The present invention relates to a motor controlling apparatus configured to control a rotation speed of a motor.

2. Description of the Related Art

Electrophotographic image forming apparatus, such as a copier and a printer, have a mechanism of forming a toner image on an image bearing member such as a photosensitive drum or an intermediate transfer belt, transferring the toner image formed on the image bearing member onto a recording material such as paper or an OHP sheet, and thereafter fixing the toner image formed on the recording material.

The photosensitive drum is designed so that a toner image is formed thereon and so as to transfer the toner image onto the intermediate transfer belt. Thus, in general, the photosensitive drum is rotated at a constant speed so as to prevent the toner image from extending and shortening.

Similarly, the intermediate transfer belt is designed so that the toner image is transferred thereto from the photosensitive drum and so as to transfer the toner image to a recording material. Thus, the intermediate transfer belt is also rotated at a constant speed equal to that of the conveyed recording material so as to prevent the toner image from extending and shortening.

Speed fluctuations in the photosensitive drum and the intermediate transfer belt both affect the reproducibility of an image finally formed on the recording material. Even image extension/shortening caused by minute unevenness in rotation speed appears on an image on the recording material as uneven density called banding, which is responsible for image degradation.

The mainstream color electrophotographic image forming apparatus are a tandem type in which photosensitive drums of four colors are provided in series and images are transferred on an intermediate transfer belt at appropriate timings so that the images may be superimposed. In the tandem type, speed fluctuations in the drums of four colors result in a deviation from a predetermined image forming position or a predetermined image transfer position, and speed fluctuations in the intermediate transfer belt result in deviated transfer positions from the photosensitive drums. An image is formed in a state where images of respective colors are deviated from their predetermined transfer positions, that is, so-called color misregistration appears on the recording material, which is responsible for image degradation. A color misregistration of 100 μm is sufficiently visually recognized as image degradation. In order to prevent image degradation caused by color misregistration as well as other factors, design is made to suppress color misregistration to be smaller than several tens of μm.

Conventionally, a driving roller configured to rotate the photosensitive drum or the intermediate transfer belt is driven by phase-locked loop (PLL) control using a brushless DC motor. In the PLL control, a signal having rotation speed information called FG signal indicating the rotation position of the motor is controlled to be synchronized with a clock signal applied from outside, to thereby enhance the stability of rotation speed. In the PLL control, a stable clock signal with a constant period and a rotation amount per constant period are synchronized with each other, and hence a constant speed is obtained. The phase-locked loop (PLL) circuit is in widespread use also as a general-purpose driver IC, and hence the PLL control is commonly used.

For driving the photosensitive drum and the intermediate transfer belt, some image forming apparatus use one or two gears having a given reduction ratio for converting the motor output into low speed high torque. In this case, there is a problem in that, as compared with the case where a motor shaft and the drum are simply directly connected to each other not via any gear, the drum speed may be unstable even when the motor speed is constant because of the eccentricity of the gear shaft. To address the problem, there is used another method of controlling the rotation speed of the drum by providing a speed sensor such as an encoder to a load shaft (driving roller for photosensitive drum or intermediate transfer belt) without using an FG signal for detecting the rotation position of the motor.

In both the control methods described above, constant speed control can be sufficiently performed when the load torque is substantially constant. However, in a system with a large load fluctuation or a system for which even a minute fluctuation is not allowable (corresponding to a color misregistration of several tens of μm), the acceleration response and deceleration response are not linear characteristics but the deceleration response depends on a friction force because of the motor driving method. Thus, high-frequency response is not obtained.

In view of the foregoing, measures have been taken to add a friction brake in order to improve the deceleration response. However, a method of improving the deceleration response without adding a friction brake is proposed in Japanese Patent Application Laid-Open NO. H06-197576.

Japanese Patent Application Laid-Open No. H06-197576 discloses the method of individually setting the gain of a controller depending on the positive sign and negative sign of a speed difference and changing the value of the gain depending on a change in temperature. However, in the controller including the integral operation for correcting a steady-state deviation for constant speed driving, the controlling apparatus disclosed in Japanese Patent Application Laid-Open No. H06-197576 cannot obtain a sufficiently stable rotation speed of a motor.

### SUMMARY OF THE INVENTION

The present invention provides a motor controlling apparatus configured to improve deceleration response and obtaining a sufficiently stable rotation speed of a motor.

According to an exemplary embodiment of the present invention, there is provided a motor controlling apparatus, including: a detector configured to detect a rotation speed of a rotary member rotated by a motor; a first control value determining portion configured to obtain a first control value in accordance with a difference between a target speed and the rotation speed; a second control value determining portion configured to obtain a second control value based on an amount of change in the first control value; and a motor controlling portion configured to control driving of the motor in accordance with the second control value.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus.

FIG. 2 is a block diagram of a PLL control system configured to drive a brushless DC motor.

FIG. 3 is a timing chart of PLL control by a 120-degree-energization method.

FIG. 4A is a response graph of speed at the time of speed control.

FIG. 4B is a response graph of a PWM duty at the time of speed control.

FIG. 4C is a response graph of generated torque at the time of speed control.

FIG. 5 is an explanatory diagram of deceleration response.

FIG. 6 is a diagram illustrating a driving portion of a photosensitive drum using a motor controlling apparatus according to a first embodiment.

FIG. 7 is a block diagram of the motor controlling apparatus according to the first embodiment.

FIG. 8 is a flowchart illustrating the operation of a CPU according to the first embodiment.

FIGS. 9A and 9B are graphs showing response in the case where the same gain is used in acceleration and deceleration in the integral operation of the conventional technology.

FIGS. 10A and 10B are graphs showing response in the case where different gains are used in accordance with the sign of a speed difference in the integral operation of the conventional technology.

FIGS. 11A and 11B are graphs showing response in the integral operation according to the first embodiment.

FIGS. 12A, 12B, and 12C are measured data according to the first embodiment.

FIG. 13 is a block diagram of a motor controlling apparatus according to a second embodiment.

FIG. 14 is a flowchart illustrating the operation of a CPU according to the second embodiment.

FIGS. 15A, 15B, and 15C are diagrams illustrating currents flowing through coils of the motor.

### DESCRIPTION OF THE EMBODIMENTS

### Image Forming Apparatus

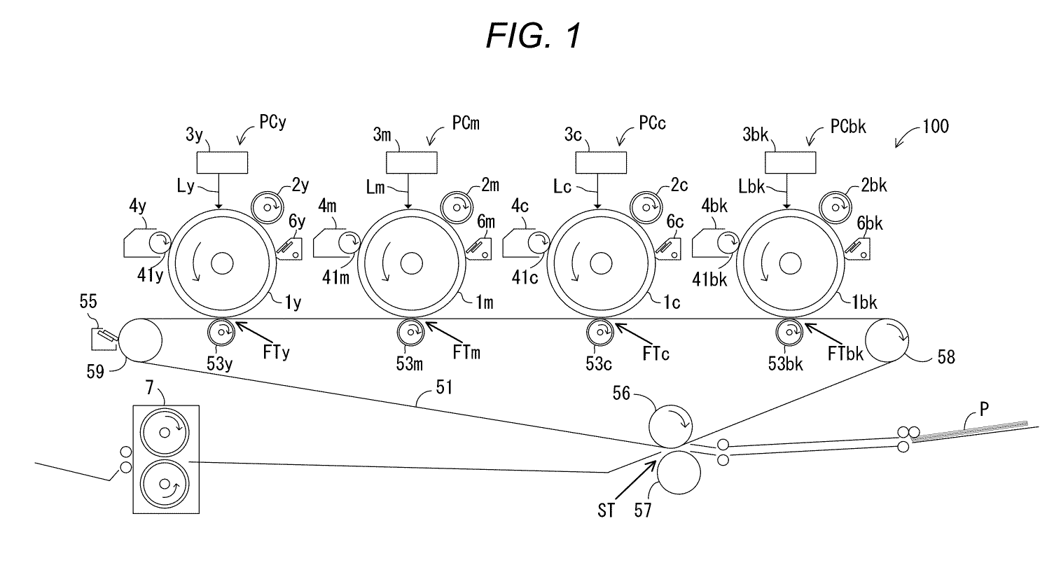

FIG. 1 is a schematic configuration diagram of an electrophotographic image forming apparatus (hereinafter referred to as “image forming apparatus”) 100. The image forming apparatus 100 includes four image forming portions PC (yellow image forming portion PCy, magenta image forming portion PCm, cyan image forming portion PCc, and black image forming portion PCbk).

In FIG. 1, reference symbols suffixed with y, m, c, and bk represent the configurations of the yellow image forming portion PCy, the magenta image forming portion PCm, the cyan image forming portion PCc, and the black image forming portion PCbk, respectively. The four image forming portions PC have the same configuration, and hence reference symbols without the suffixes y, m, c, and bk are used in the following description.

Each of the four image forming portions PC includes a photosensitive drum (image bearing member) 1, a charging roller 2, an exposure device 3, a developing unit 4, a developing sleeve 41 provided in the developing unit 4, a primary transfer roller 53, and a drum cleaner 6. The image forming apparatus 100 is of a tandem type including four photosensitive drums 1 in series.

Below the four photosensitive drums 1, an intermediate transfer belt 51 is disposed in a rotatable manner. The intermediate transfer belt 51 is passed over a driving roller 58, a driven roller 59, and a secondary transfer opposed roller 56. The intermediate transfer belt 51 is sandwiched between the photosensitive drum 1 and the primary transfer roller 53 to form a primary transfer portion FT between the photosensitive drum 1 and the intermediate transfer belt 51.

A belt cleaner 55 is provided in contact with the intermediate transfer belt 51 so as to be opposed to the driven roller 59. A secondary transfer roller 57 is provided in contact with the intermediate transfer belt 51 so as to be opposed to the secondary transfer opposed roller 56. The secondary transfer opposed roller 56 and the secondary transfer roller 57 sandwich the intermediate transfer belt 51 to form a secondary transfer portion ST between the intermediate transfer belt 51 and the secondary transfer roller 57.

A recording material P such as paper or an OHP sheet is fed to the secondary transfer portion ST from a feeding portion (not shown). A fixing unit 7 is disposed downstream of the secondary transfer portion ST.

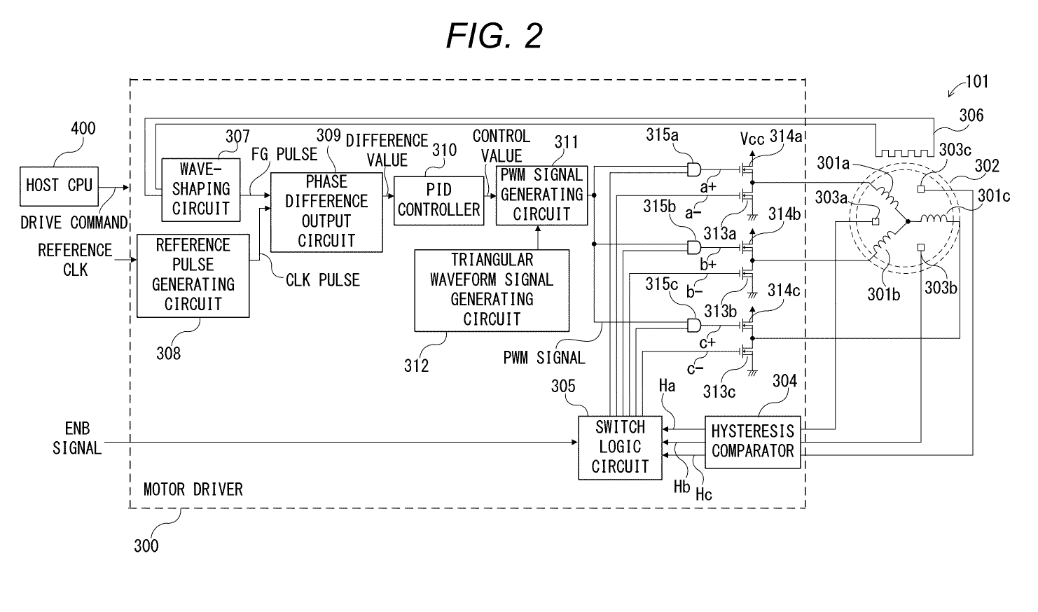

A host CPU 400 (FIG. 2) controls the overall image forming apparatus 100. In response to an image forming command, the host CPU 400 starts to rotate the photosensitive drum 1, the driving roller 58 for the intermediate transfer belt 51, the charging roller 2, the developing sleeve 41, the primary transfer roller 53, the secondary transfer roller 57, and the fixing roller 7.

The charging roller 2 is connected to a high voltage power source (not shown). The high voltage power source (not shown) applies to the charging roller 2 a DC voltage or a superimposed voltage having a sine waveform voltage superimposed on a DC voltage. The charging roller 2 uniformly charges the surface of the photosensitive drum 1. The exposure device 3 irradiates the charged surface of the photosensitive drum 1 with laser light L which is modulated in accordance with an image signal, and forms an electrostatic latent image on the surface of the photosensitive drum 1.

The developing sleeve 41 of the developing unit 4 is connected to a high voltage power source (not shown). The high voltage power source (not shown) applies to the developing sleeve 41 a superimposed voltage having an AC voltage superimposed on a DC voltage. The developing sleeve 41 develops the electrostatic latent image formed on the photosensitive drum 1 into a toner image by a developer (toner).

The toner images formed on the four photosensitive drums 1 are sequentially transferred onto the intermediate transfer belt 51 in a superimposing manner at the respective primary transfer portions FT by the respective primary transfer rollers 53. The superimposed toner images are transferred onto the recording material P at the secondary transfer portion ST by the secondary transfer roller 57. Note that, the primary transfer roller 53 and the secondary transfer roller 57 are also applied with a DC voltage for transferring the toner image from a high voltage power source (not shown). Transfer residual toner remaining on the photosensitive drum 1 is scraped off and collected by the drum cleaner 6. Transfer residual toner remaining on the intermediate transfer belt 51 is scraped off and collected by the belt cleaner 55. The toner images transferred onto the recording material P are heated and pressed by the fixing unit 7 and fixed onto the recording material P as a color image.

(Underlying Technology)

First, a motor driver 300 as the underlying technology of the present invention will be described. Based on the underlying technology, the driving principle of a three-phase brushless DC motor (hereinafter referred to as “motor”) 101 will be described, and deceleration response will be described thereafter.

FIG. 2 is a block diagram of a PLL control system configured to drive the motor 101. The motor driver 300 drives the motor 101 by PLL control using PID control. The method of driving the motor 101 is a 120-degree-energization with rectangular-waveform driving.

The motor 101 includes a stator having coils 301a, 301b, and 301c and Hall elements (rotation position sensors) 303a, 303b, and 303c, and a rotor 302 having a permanent magnet.

When the rotor 302 incorporating the permanent magnet rotates, the magnetic flux passing through the Hall element 303 (303a, 303b, 303c) changes. The Hall element 303 generates a voltage in proportion to magnetic flux density. A hysteresis comparator 304 in the motor driver 300 converts the voltage generated by the Hall element 303 into a voltage signal H (Ha, Hb, Hc) indicating the position of the rotor 302. The hysteresis comparator 304 outputs the voltage signal H to a switch logic circuit 305.

The switch logic circuit 305 selects the coil 301a, 301b, or 301c through which a current is caused to flow based on the voltage signal H (Ha, Hb, Hc) of the hysteresis comparator 304, and produces a switching pattern for causing a current to flow through the selected coil 301. An ENB signal to be input to the switch logic circuit 305 is a signal for instructing ON/OFF of the driving of the motor 101. When the ENB signal is OFF, the switch logic circuit 305 produces a switching pattern for turning OFF the flow of currents to all the coils 301.

An FG pattern (detector) 306 serving as a sensor configured to detect the rotation speed of the rotor 302 is disposed opposite to the permanent magnet of the rotor 302. Utilizing the principle that the change in magnetic flux generates a current, the FG pattern 306 generates an FG signal which is a sine waveform having a frequency corresponding to the rotation speed of the rotor 302. The FG signal is input to a wave-shaping circuit 307 in the motor driver 300. The wave-shaping circuit 307 generates a FG pulse at a zero-crossing point of the FG signal. The wave-shaping circuit 307 outputs the FG pulse to a phase difference output circuit 309.

A reference clock signal (reference CLK) that instructs a target speed is input to a reference pulse generating circuit 308 from the outside. The reference pulse generating circuit 308 generates a CLK pulse (reference clock pulse) at an edge (CLK edge) of the reference clock signal. The reference pulse generating circuit 308 outputs the CLK pulse to the phase difference output circuit 309.

The phase difference output circuit 309 converts a phase difference between the FG pulse and the CLK pulse into a difference value. The phase difference output circuit 309 outputs the difference value to a PID controller 310.

The PID controller 310 performs the proportional, integral, and derivative operations on the difference value, thereby deriving a control value from the difference value. The PID controller 310 outputs the control value to a PWM signal generating circuit 311.

A triangular waveform signal generating circuit 312 generates a triangular waveform signal for pulse width modulation, and outputs the triangular waveform signal to the PWM signal generating circuit 311.

The PWM signal generating circuit 311 compares the control value with the triangular waveform signal to generate a pulse-width modulated signal (hereinafter referred to as “PWM signal”). The PWM signal generating circuit 311 outputs the PWM signal to AND circuits 315a, 315b, and 315c. The PWM signal is input to the AND circuits 315a, 315b, and 315c as a drive signal for driving the motor 101.

The AND circuits 315a, 315b, and 315c are connected to field effect transistors (hereinafter referred to as “FETs”) 314a, 314b, and 314c, respectively. The AND circuits 315a, 315b, and 315c are connected also to the switch logic circuit 305.

FETs 313a, 313b, and 313c are connected to the switch logic circuit 305. The coil 301a of the motor 101 is connected to the FET 313a and the FET 314a. The coil 301b is connected to the FET 313b and the FET 314b. The coil 301c is connected to the FET 313c and the FET 314c.

The FETs 313a, 313b, and 313c are connected to the ground. The FETs 314a, 314b, and 314c are connected to a power supply Vcc.

The switch logic circuit 305 transmits switch signals a−, b−, and c− to the FETs 313a, 313b, and 313c in accordance with the voltage signals Ha, Hb, and Hc output from the hysteresis comparator 304, respectively. In response to the switch signals a−, b−, c−, the FETs 313a, 313b, and 313c are turned ON.

The AND circuits 315a, 315b, and 315c transmit switch signals a+, b+, and c+ to the FETs 314a, 314b, and 314c in accordance with the signals output from the switch logic circuit 305, respectively. The switch signals a+, b+, and c+ are PWM signals. In response to the switch signals a+, b+, and c+, the FETs 314a, 314b, and 314c are repeatedly turned ON and OFF in accordance with the PWM signals.

In other words, based on the switching pattern obtained from the switch logic circuit 305, the FETs 313a, 313b, and 313c are respectively switched by the switch signals a−, b−, and c− from the switch logic circuit 305. The FETs 314a, 314b, and 314c are respectively switched by the switch signals a+, b+, and c+, which are the logical AND of the PWM signal for changing the amount of coil current and the switching pattern in the AND circuits 315a, 315b, and 315c. The voltage of the power supply Vcc is used for driving the motor 101. In this way, the current to be caused to flow through the coil 301a, 301b, or 301c is switched in accordance with the position of the rotor 302, that is, the position of the magnet, and the amount of current is controlled by PWM control. Thus, the motor 101 is rotated at a desired speed.

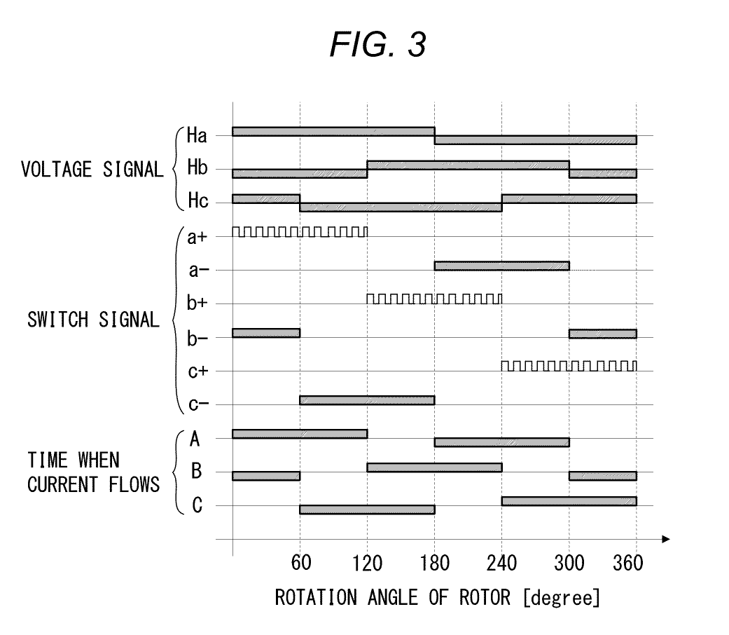

FIG. 3 illustrates a timing chart of the respective signals of the switching pattern. A, B, and C represent timings when the currents flow through the coils 301a, 301b, and 301c.

How the deceleration response of the PLL control system illustrated in FIG. 2 depends on a friction force will be described below.

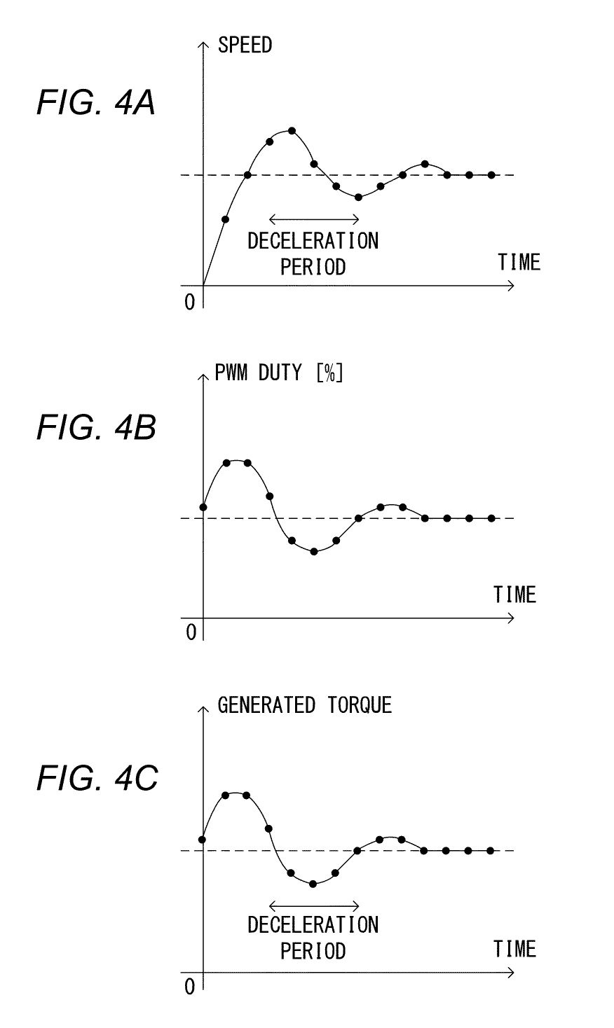

FIG. 4B shows a change in duty cycle (hereinafter referred to as “PWM duty”) of a PWM signal subjected to speed control against a speed change caused by disturbance. FIG. 4C shows a change in generated torque. As a constant speed control is step target value tracking control, the constant speed control is I (integral) control for the sake of simplicity. In general, the generated torque is proportional to a coil current value, and the coil current value is proportional to the PWM duty (the relationship: generated torque ∝ coil current value ∝ PWM duty). As understood from FIGS. 4A to 4C, even when the actual speed exceeds a target speed, a control of decreasing the speed of the generated torque by a negative torque with respect to the rotation direction is not performed. Instead, the generated torque is reduced to decrease the speed by a friction force.

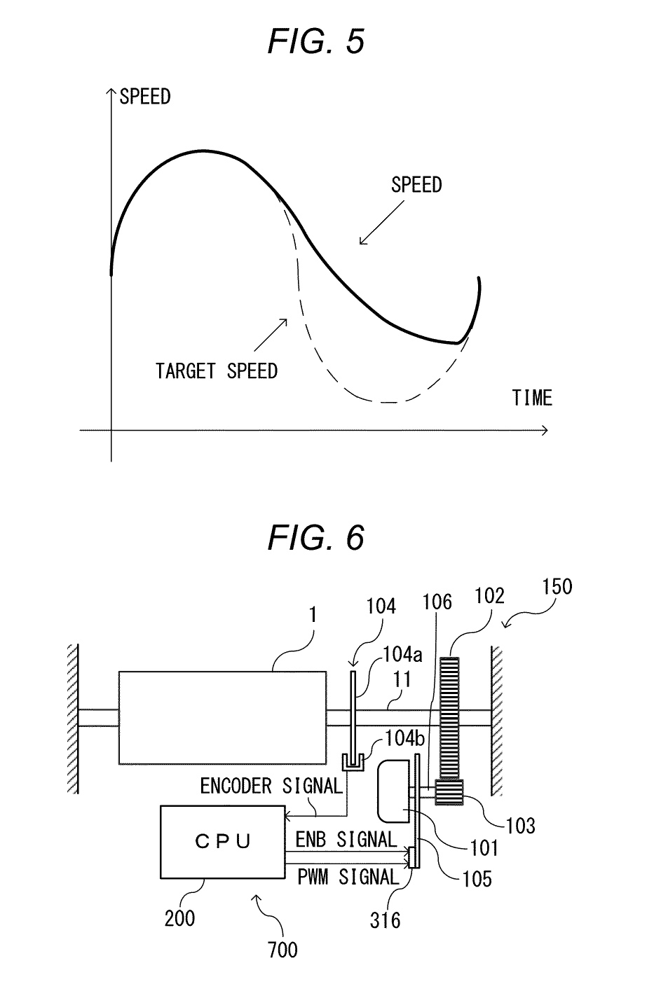

The advantage of this method is that the PWM duty is converged on a value matching with load torque. The disadvantage is that, as shown in FIG. 5, when the response frequency is high, the control value instructed by the controller cannot always reduce the speed because of a small friction force at a frequency at which the acceleration response can be obtained.

In the constant speed driving in the image forming apparatus, a phenomenon that the deceleration response cannot be obtained as shown in FIG. 5 is a problem. Thus, measures have been taken to add an additional friction brake.

Now, embodiments in which the deceleration response is improved without any additional friction member will be described below.

### First Embodiment

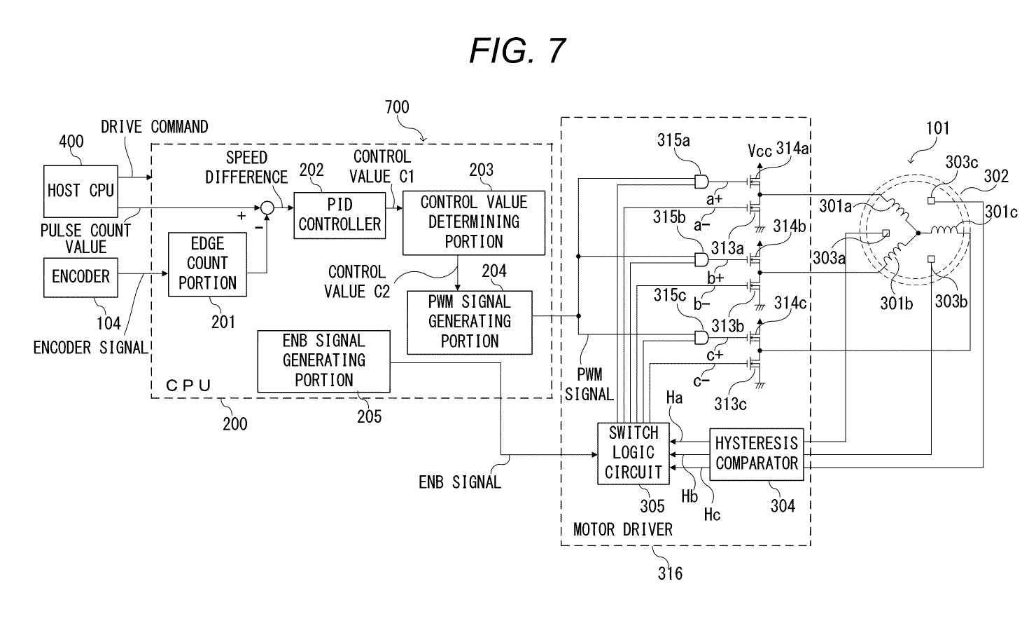

Referring to FIG. 6 to FIGS. 12A to 12C, a motor controlling apparatus 700 according to a first embodiment will be described.

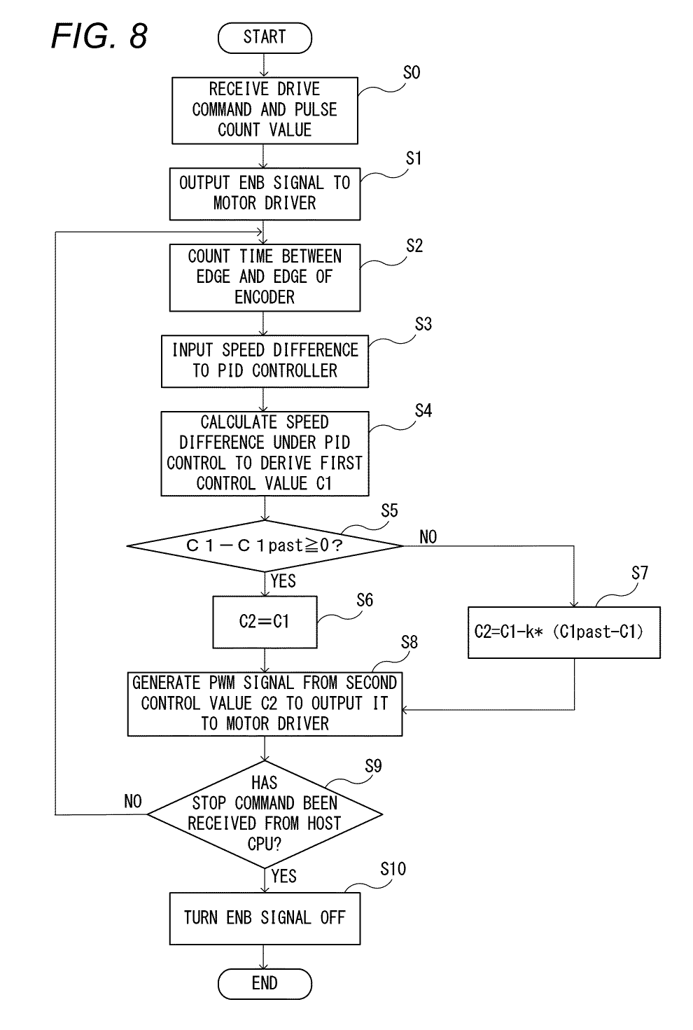

FIG. 6 is a driving portion 150 of a photosensitive drum (rotary member) 1 using the motor controlling apparatus 700 according to the first embodiment. FIG. 7 is a block diagram of the motor controlling apparatus 700 according to the first embodiment. In FIG. 7, the same structures as those illustrated in FIG. 2 are denoted by the same reference symbols.

As illustrated in FIG. 7, the motor controlling apparatus 700 includes a motor driver 316 configured to drive the motor 101, and a CPU (controller) 200 configured to control the motor driver 316.

The motor 101 drives the photosensitive drum 1 of the image forming apparatus 100. The motor controlling apparatus 700 controls the motor 101 to perform constant speed control of the photosensitive drum 1.

As illustrated in FIG. 7, the motor 101 includes windings in star connection (Y-connection) of three coils 301a, 301b, and 301c. The motor 101 is driven by a 120-degree-energization method. The motor 101 is driven by bipolar driving in which six FETs (semiconductor elements) 313a, 313b, 313c, 314a, 314b, and 314c are used to cause a bidirectional current to flow through the coils 301a, 301b, and 301c.

As illustrated in FIG. 6, the motor 101 and the motor driver 316 are mounted on the same substrate 105. A drum gear 102 is fixed to a drum shaft (rotary shaft) 11 of the photosensitive drum 1. The drum gear 102 is engaged with a motor gear 103 fixed to a motor shaft (rotary shaft) 106 of the motor 101. Driving of the motor 101 is transmitted to the photosensitive drum 1 via the motor shaft 106, the motor gear 103, the drum gear 102, and the drum shaft 11, so that the photosensitive drum 1 rotates. Further, an encoder (detector) 104 serving as a rotation speed detector is fixed to the drum shaft 11. The encoder 104 includes a disc 104a and a photosensor 104b. The disc 104a is provided with multiple slits (light transmitting portions) printed at equal intervals. The encoder 104 detects a slit of the disc 104a through which light transmits to the photosensor 104b, and outputs an ON/OFF signal (encoder signal). The encoder signal is input to the CPU 200. The CPU 200 uses the encoder signal to generate a PWM signal for adjusting the rotation speed of the photosensitive drum 1 to a target speed and an ENB signal for determining ON/OFF of driving of the motor 101. The CPU 200 outputs the PWM signal and the ENB signal to the motor driver 316.

The CPU 200 includes an edge count portion 201, a PID controller (first determining portion) 202, a control value determining portion (second determining portion) 203, a PWM signal generating portion (motor controlling portion) 204, and an ENB signal generating portion 205.

The motor driver 316 includes a hysteresis comparator 304, a switch logic circuit 305, an AND circuit 315, and FETs 313 and 314.

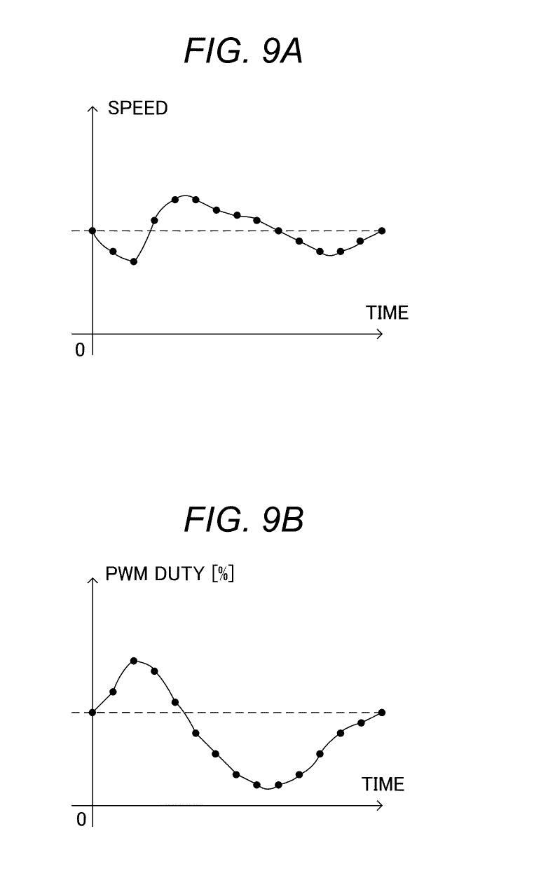

FIG. 8 is a flowchart illustrating the operation of the CPU 200 according to the first embodiment.

In response to an image forming command from a user, the host CPU 400 transmits a drive command and a pulse count value to the CPU 200 through serial communications. The pulse count value represents a target speed (target rotation speed information) of the photosensitive drum 1. The CPU 200 receives the drive command and the pulse count value from the host CPU 400 (S0). When receiving the drive command, the CPU 200 outputs the ENB signal from the ENB signal generating portion 205 to the motor driver 316 (S1).

The edge count portion 201 counts a time between rising edges or falling edges of the encoder signal from the encoder 104, to thereby calculate a count value (S2). The count value represents a detection speed (detected rotation speed information) indicating a detected actual rotation speed of the photosensitive drum 1.

The CPU 200 inputs a difference between the pulse count value of the host CPU 400 and the count value of the edge count portion 201 to the PID controller 202 as a speed difference (speed error) (S3). The speed difference can be calculated by subtracting the detection speed detected by the encoder 104 from the target speed. The CPU 200 performs a PID control calculation based on the speed difference by the PID controller 202, to thereby derive a first control value C1 (S4). The PID controller 202 outputs the first control value C1 to the control value determining portion 203.

The control value determining portion 203 samples the first control value C1 once every predetermined period.

The control value determining portion 203 may include a storage device configured to store the sampled first control value C1. The control value determining portion 203 derives a second control value C2 based on the magnitude relation between the first control value C1 and a first control value C1past which is derived in the previous sampling.

Specifically, the CPU 200 causes the control value determining portion 203 to determine whether “C1−C1past” is 0 (zero) or more (S5). When “C1−C1past” is 0 or more (YES in S5), that is, when the first control value C1 is equal to or larger than the first control value C1past derived in the previous sampling, the CPU 200 sets the first control value C1 as the second control value C2 (C2=C1) (S6).

On the other hand, when determining that the first control value C1 has decreased from the first control value C1past previously sampled, the control value determining portion 203 calculates a second control value C2 smaller than the first control value C1.

Specifically, when “C1−C1past” is smaller than 0 (NO in S5), that is, when the first control value C1 is smaller than the first control value C1past derived in the previous sampling, the second control value C2 is calculated based on the expression: C2=C1−k×(C1past−C1) (S7). In this expression, “k” is a coefficient which is adjusted so that the acceleration response and the deceleration response may be equal to each other when the absolute value |C1past−C1| of the amount of change in the first control value C1 is equal in both acceleration and deceleration. “k” is a positive integer, but is not limited thereto.

The control value determining portion 203 outputs the second control value C2 to the PWM signal generating portion 204.

The second control value C2 is used for changing the duty cycle of a PWM signal generated by the PWM signal generating portion 204. The duty cycle “PWM duty” of the PWM signal is obtained by dividing a pulse width “τ” by the period T of the pulse signal.

$$PWMDuty = \frac{τ}{T} \times 100 \%$$

The PWM signal generating portion 204 includes a counter (not shown) configured to count one period of the pulse signal from 0 (zero) to a maximum value, and a comparator (not shown) configured to compare a count value of the counter and the second control value C2. When the second control value C2 is equal to or larger than the count value, the PWM signal generating portion 204 sets the voltage level of the pulse signal to High, and, when the second control value C2 is smaller than the count value, the PWM signal generating portion 204 sets the voltage level of the pulse signal to Low, to thereby generate a PWM signal. The PWM signal generating portion 204 functions as an adjusting unit configured to adjust the amount of current for driving the motor 101 in accordance with the second control value C2.

The CPU 200 outputs the PWM signal from the PWM signal generating portion 204 to the AND circuits (current adjusting units) 315a, 315b, and 315c of the motor driver 316 (S8). The AND circuit 315 changes the amount of current flowing through the coils 301 of the motor 101 based on the PWM signal.

Now, how to derive the second control value C2 by the control value determining portion 203 will be described below by way of an example where the absolute value of “C1−C1past” is equal in both acceleration and deceleration. The duty cycles of the PWM signals controlled by the first control value C1 and the second control value C2 are placed between parentheses after C1 and C2, respectively.

First, a description will be provided of an example where the absolute value |C1past−C1| of the amount of change in the first control value C1 at the time of acceleration is 1.

The first control value C1 input from the PID controller 202 to the control value determining portion 203 is C1(51%). C1(51%) represents a first control value for setting the duty cycle of the PWM signal to 51%. The first control value C1past, which is derived in the previous sampling of the first control value C1(51%), is C1past (50%).

The CPU 200 causes the control value determining portion 203 to determine whether “C1−C1past” is 0 (zero) or more.

C1(51%)−C1past(50%)=51−50=1≧0

The above calculation finds that C1−C1past is 0 or more, and hence the first control value C1 (51%) is set as the second control value C2 (51%).

In other words, the duty cycle of the PWM signal is increased from 50% to 51% by 1%, which is the same as the absolute value of 1 of the amount of change in the first control value C1, to thereby accelerate the motor 101.

Next, a description will be provided of an example where the absolute value |C1past−C1| of the amount of change in the first control value C1 at the time of deceleration is 1.

The first control value C1 input from the PID controller 202 to the control value determining portion 203 is C1 (50%). The first control value C1past, which is derived in the previous sampling of the first control value C1 (50%), is C1past (51%).

The CPU 200 causes the control value determining portion 203 to determine whether “C1−C1past” is 0 (zero) or more.

C1(50%)−C1past(51%)=50−51=−1<0

The above calculation finds that “C1−C1past” is smaller than 0, and hence the second control value C2 is calculated based on the expression: C2=C1−k×(C1past−C1). In this case, k=2.

C1−k×(C1past−C1)=50−2×(51−50)=48

From the above calculation, a second control value C2 (48%) is calculated. The second control value C2 (48%) is smaller than the first control value C1 (50%).

In other words, the duty cycle of the PWM signal is decreased from 51% to 48% by 3%, which is larger than the absolute value of 1 of the amount of change in the first control value C1, to thereby decelerate the motor 101.

In this way, even when the absolute value |C1past−C1| of the amount of change in the first control value C1 is equal in both acceleration and deceleration, the amount of change in control value at the time of deceleration (in this example, the decrease amount of 3%) can be set larger than the amount of change in control value at the time of acceleration (in this example, the increase amount of 1%). Thus, the deceleration response can be improved.

The Hall element (rotation position detector) 303 (303a, 303b, 303c) generates a voltage that changes depending on the rotation of the rotor 302. The Hall element functions as a detector configured to detect the rotation position of the rotor 302.

The hysteresis comparator 304 of the motor driver 316 converts the voltage generated by the Hall element 303 into a voltage signal H (Ha, Hb, Hc) indicating the position of the rotor 302. The hysteresis comparator 304 outputs the voltage signal H to the switch logic circuit (current switching unit) 305.

The switch logic circuit 305 instructs the switching of the current flowing through the coil 301 of the motor 101 based on the voltage signal H output from the Hall element 303. In other words, based on the voltage signal H of the hysteresis comparator 304, the switch logic circuit 305 selects the coil 301a, 301b, or 301c through which a current is caused to flow, and generates a switching pattern for causing a current to flow through the selected coil 301.

Based on the switching pattern, the switch logic circuit 305 transmits signals to the AND circuits 315a, 315b, and 315c and the FETs 313a, 313b, and 313c. Specifically, the switch logic circuit 305 transmits switch signals a−, b−, and c− to the FETs 313a, 313b, and 313c in accordance with the voltage signals Ha, Hb, and Hc output from the hysteresis comparator 304, respectively. In response to the switch signals a−, b−, and c−, the FETs 313a, 313b, and 313c are turned ON. In other words, based on the switching pattern obtained from the switch logic circuit 305, the FETs 313a, 313b, and 313c are respectively switched by the switch signals a−, b−, and c− from the switch logic circuit 305.

Further, the AND circuits 315a, 315b, and 315c respectively transmit switch signals a+, b+, and c+, which are the logical AND of the signal (switching pattern) obtained from the switch logic circuit 305 and the PWM signal of the PWM signal generating portion 204, to the FETs 314a, 314b, and 314c. The FETs 314a, 314b, and 314c are switched by the switch signals a+, b+, and c+, respectively.

By switching the FETs 313a, 313b, and 313c and the FETs 314a, 314b, and 314c, the current to be caused to flow through the coil 301a, 301b, or 301c can be switched in accordance with the switching pattern of the switch logic circuit 305.

In this way, the current to be caused to flow through the coil 301a, 301b, or 301c is switched in accordance with the position of the rotor 302 (the position of the magnet), to thereby rotate the motor 101. Further, the amount of current can be controlled based on the PWM signal generated by the PWM signal generating portion 204, and hence the motor 101 rotates the drum shaft 11 constantly at a target speed corresponding to the pulse count value output from the host CPU 400.

Returning to FIG. 8, the CPU 200 determines whether or not a stop command has been received from the host CPU 400 (S9). When the stop command has not been received from the host CPU 400 (NO in S9), the CPU 200 repeats the steps of S2 to S8 to control the rotation speed of the motor 101. When the stop command has been received from the host CPU 400 (YES in S9), the CPU 200 stops the control calculation, and turns OFF the ENB signal of the ENB signal generating portion 205 (S10). The ENB signal is input to the switch logic circuit 305 from the ENB signal generating portion 205 of the CPU 200. When the ENB signal is OFF, the switch logic circuit 305 has a switching pattern to turn OFF the flow of all the currents to the coils 301.

According to the first embodiment, the deceleration response can be improved to widen the control bandwidth.

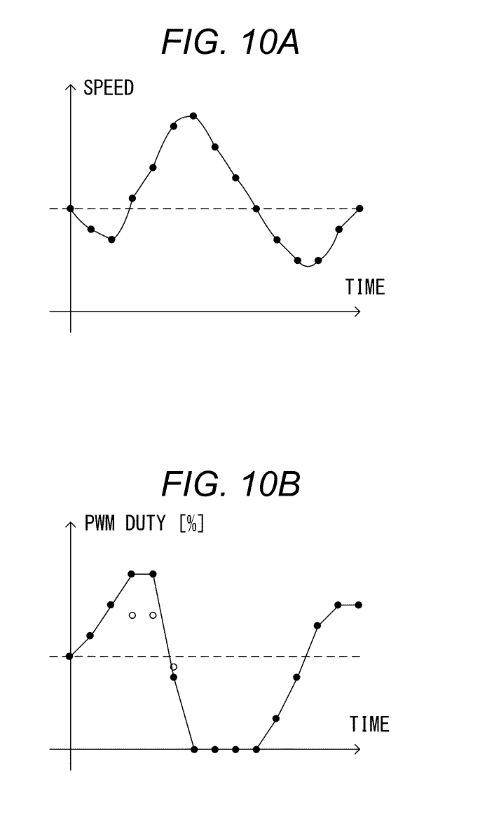

Referring to FIGS. 9A, 9B, 10A, 10B, 11A, and 11B, a comparison is made between the first embodiment and the conventional technology. Although PID control is actually performed, for easy understanding of the phenomenon, the behavior of response in the integral operation alone is schematically illustrated.

FIGS. 9A and 9B are graphs showing response in the case where the same gain is used in both acceleration and deceleration in the integral operation of the conventional technology. FIG. 9A is a graph showing a change in speed with respect to time. FIG. 9B is a graph showing a change in duty cycle (PWM duty) of a PWM signal with respect to time.

The graphs show that, even when the amount of change in PWM duty in deceleration is equivalent to the amount of change in PWM duty in acceleration, the speed is gradually decreased, and the deceleration response is delayed.

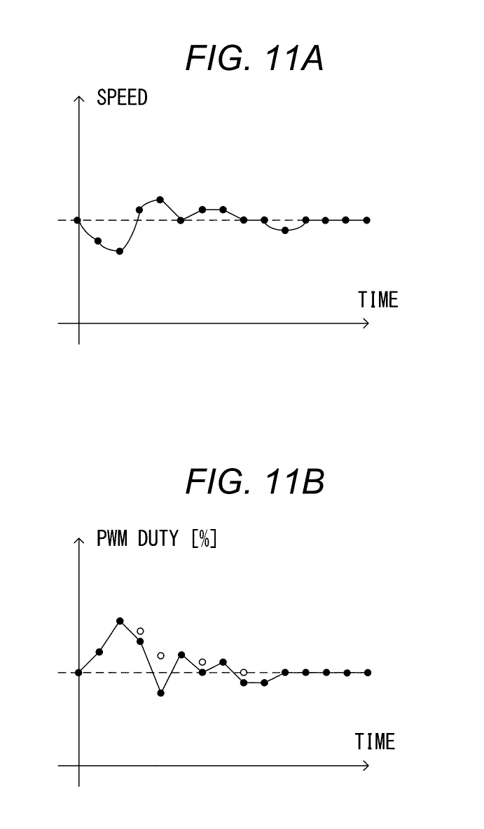

FIGS. 10A and 10B are graphs showing the response in the case where different gains are used in accordance with the sign of the speed difference in the integral operation of the conventional technology. FIG. 10A is a graph showing a change in speed with respect to time. FIG. 10B is a graph showing a change in PWM duty with respect to time.

When the speed difference is positive, the gain is 1. When the speed difference is negative, the gain is 2. White circles represent the PWM duty when there is no gain correction in the same sampling time. When a white circle does not appear in the same sampling time, the white circle lies on the black circle.

The timing of the change in sign (positive sign and negative sign) of the speed difference is not always coincident with the direction of the PWM duty, and hence oscillation occurs. Oscillation does not occur as long as the control is performed by the proportional operation alone, but, in constant speed driving at a target speed, it is not realistic to avoid the use of the integral operation in consideration of a steady-state difference.

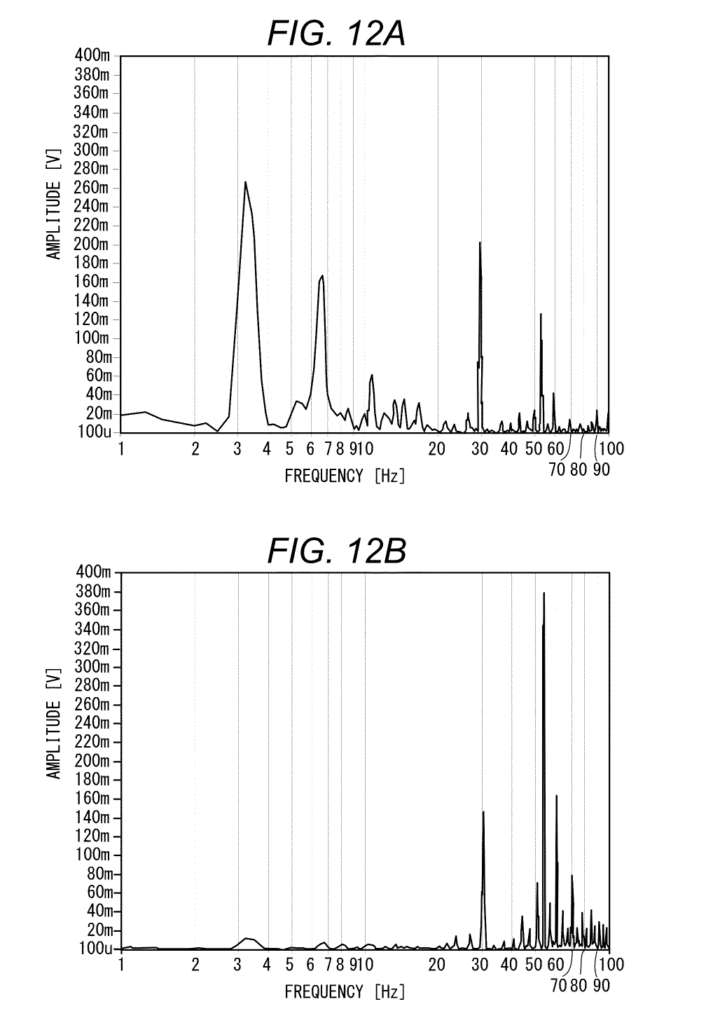

FIGS. 11A and 11B are graphs showing response in the integral operation according to the first embodiment. FIG. 11A is a graph showing a change in speed with respect to time. FIG. 11B is a graph showing a change in PWM duty with respect to time.

FIGS. 11A and 11B show the response in the case where the gain is 1 under the condition of “first control value C1>C1past” and “k” is 2 in the expression: C2=C1−k×(C1past−C1).

White circles represent the PWM duty when there is no gain correction in the same sampling time. When a white circle does not appear in the same sampling time, the white circle lies on the black circle.

Only when the amount of change in the first control value C1 is negative, the PWM duty is greatly decreased to improve the deceleration response. When the amount of change in the first control value C1 is 0 (zero) or more, the value of the first control value C1 from the PID controller 202 is maintained (C2=C1). Thus, according to the first embodiment, the PWM duty is converged swiftly to a value corresponding to the target speed.

In this way, according to the first embodiment, the deceleration response can be improved, and the convergence characteristics of the duty cycle of the PWM signal can be maintained as well.

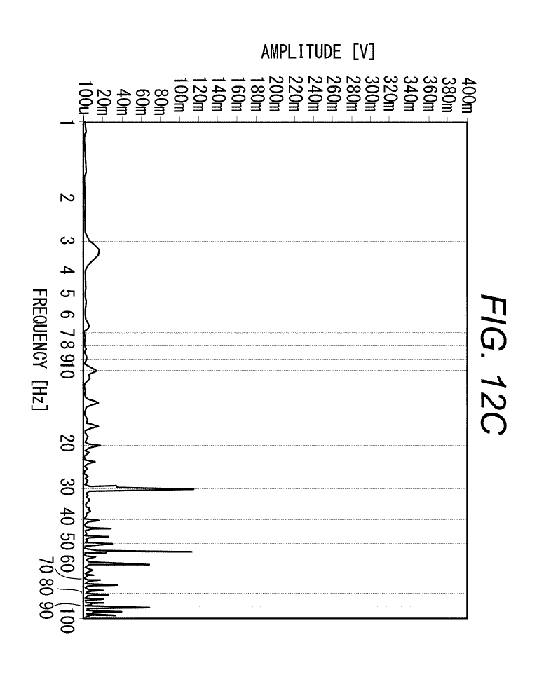

FIGS. 12A to 12C show measured data according to the first embodiment. The measured data are results of subjecting the speed difference to FFT analysis, showing the intensity of the speed difference for each frequency. FIG. 12A is the result of an open-loop, fixed PWM duty cycle, FIG. 12B is the result of PID control alone, and FIG. 12C is the result of the same PID control as in FIG. 12B plus the control in the first embodiment. In FIG. 12A, 3.3 Hz and 6.6 Hz correspond the eccentric period of the drum gear 102 and the second harmonic thereof, respectively. 30 Hz is the period of rotation unevenness per one revolution of the motor 101. When the control is performed, the speed difference is suppressed at a low frequency both in FIG. 12B and in FIG. 12C. In FIG. 12B, however, the deceleration response is not obtained at a high frequency, and hence oscillation is observed at 30 Hz or more. According to the first embodiment, the motor can maintain the response performance also at a high frequency as shown in FIG. 12C.

According to the first embodiment, the deceleration response can be improved without adding any friction member, and the deceleration response equivalent in performance to the acceleration response can be obtained. Besides, there is no influence on the control value of the PID controller, and hence the PWM duty can be converged on a value corresponding to a target speed so that the actual speed may be stable at the target speed.

In the first embodiment, the encoder 104 is used for detecting the rotation speed of the drum shaft 11 of the photosensitive drum 1. However, the rotation speed of the motor shaft 106 of the motor 101 may be detected instead of that of the drum shaft 11 of the photosensitive drum 1. In order to detect the rotation speed of the motor shaft 106 of the motor 101, an FG signal which is a sine waveform at the frequency corresponding to the rotation speed of the motor 101 may be detected based on an FG pattern (detector). Alternatively, an encoder signal from an encoder (detector) separately mounted to the motor shaft 106 may be input to the edge counting portion 201 of the CPU 200.

The first embodiment has been described above by using the motor controlling apparatus 700 for the motor 101 that rotates the photosensitive drum 1. However, the present invention is applicable also to a motor controlling apparatus for a motor that rotates the intermediate transfer belt (rotary member) 51. In other words, the present invention is applicable to a motor controlling apparatus configured to rotate an object at a constant speed by a brushless DC motor.

### Second Embodiment

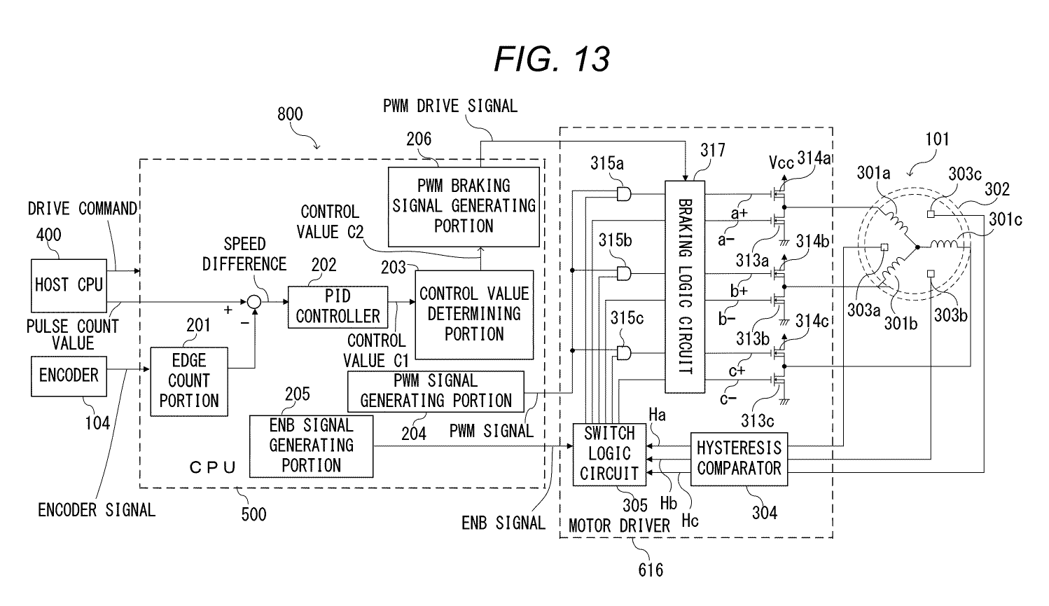

Next, referring to FIGS. 13 and 14 and FIGS. 15A to 15C, a motor controlling apparatus 800 according to a second embodiment will be described. A driving portion of a photosensitive drum according to the second embodiment has the same configuration as that in the first embodiment illustrated in FIG. 6, and hence description thereof is omitted. FIG. 13 is a block diagram of the motor controlling apparatus 800 according to the second embodiment. In the second embodiment, the same components as those in the first embodiment are denoted by the same reference symbols to omit description thereof.

The second embodiment is different from the first embodiment in that a phase-to-phase short circuit, namely so-called an electric brake, is used in an OFF period of the PWM signal. The phase-to-phase short circuit means the state where the FETs 314a, 314b, and 314c are turned OFF and the FETs 313a, 313b, and 313c are turned ON regardless of the selection by the switch logic circuit 305 in FIG. 13.

As illustrated in FIG. 13, the motor controlling apparatus 800 includes a motor driver 616 configured to drive the motor 101, and a CPU (controller) 500 configured to control the motor driver 616.

The CPU 500 includes the edge count portion 201, the PID controller 202, the control value determining portion 203, the PWM signal generating portion 204, the ENB signal generating portion 205, and a PWM braking signal generating portion (motor controlling portion) 206.

The motor driver 616 includes the hysteresis comparator 304, the switch logic circuit 305, the AND circuit 315, a braking logic circuit (short-circuit switch unit) 317, and the FETs 313 and 314.

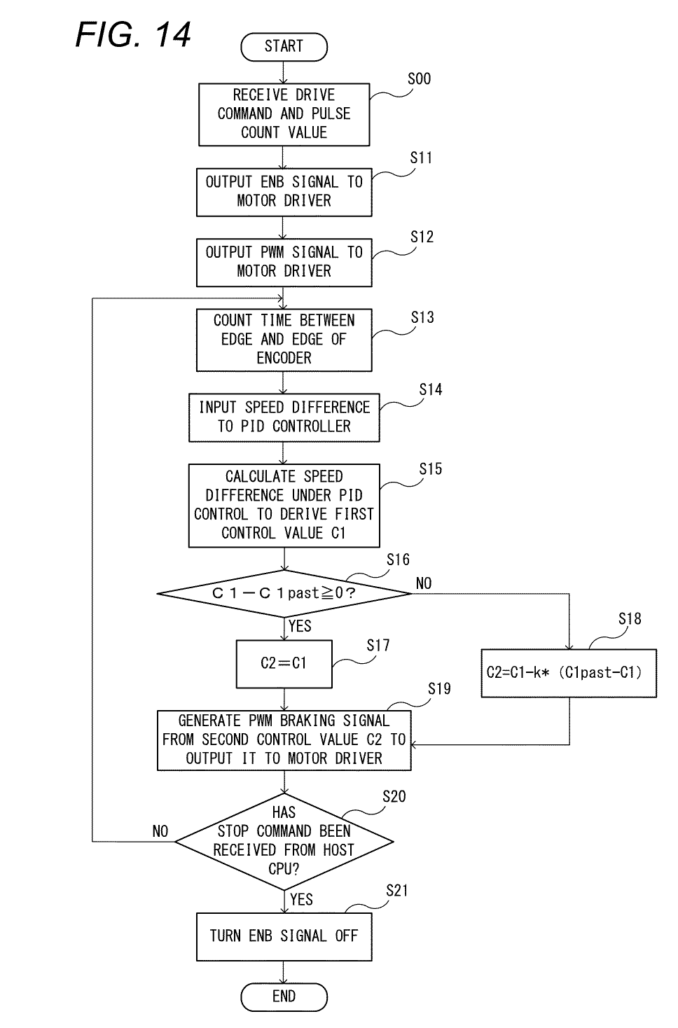

FIG. 14 is a flowchart illustrating the operation of the CPU 500.

In response to an image forming command from the user, the host CPU 400 transmits a drive command and a pulse count value to the CPU 500 through serial communications. The pulse count value represents a target speed (target rotation speed information) of the photosensitive drum 1. The CPU 500 receives the drive command and the pulse count value from the host CPU 400 (S00). When receiving the drive command, the CPU 500 outputs the ENB signal to the motor driver 616 from the ENB signal generating portion 205 (S11).

Next, the CPU 500 outputs a PWM signal from the PWM signal generating portion 204 to the motor driver 616 (S12). In this case, the duty cycle of the PWM signal is 100%. Alternatively, the duty cycle of the PWM signal may be set to an arbitrary fixed value. Still alternatively, the PWM signal may be generated by the control value determining portion 203 in accordance with a second control value C2 because an electric brake switching pattern obtained by a PWM braking signal to be described later is given priority over the PWM signal.

The edge count portion 201 counts a time between rising edges or falling edges of the encoder signal from the encoder 104, to thereby calculate a count value (S13). The count value represents a detection speed (detected rotation speed information) indicating a detected actual rotation speed of the photosensitive drum 1.

The CPU 500 inputs a difference between the pulse count value of the host CPU 400 and the count value of the edge count portion 201 to the PID controller 202 as a speed difference (speed error) (S14). The speed difference can be calculated by subtracting the detection speed detected by the encoder 104 from the target speed. The CPU 500 causes the PID controller 202 to perform the PID control calculation based on the speed difference, to thereby derive a first control value C1 (S15). The PID controller 202 outputs the first control value C1 to the control value determining portion 203.

The control value determining portion 203 samples the first control value C1 once every predetermined period. The control value determining portion 203 may include a storage device configured to store the sampled first control value C1. The control value determining portion 203 derives a second control value C2 based on the magnitude relation between the first control value C1 and the first control value C1past which is derived in the previous sampling.

Specifically, the CPU 500 causes the control value determining portion 203 to determine whether “C1−C1past” is 0 (zero) or more (S16). When “C1−C1past” is 0 or more (YES in S16), that is, when the first control value C1 is equal to or larger than the first control value C1past derived in the previous sampling, the CPU 500 sets the first control value. C1 as the second control value C2 (C2=C1) (S17).

On the other hand, when determining that the first control value C1 has decreased from the first control value C1past previously sampled, the control value determining portion 203 calculates a second control value C2 smaller than the first control value C1.

Specifically, when “C1−C1past” is smaller than 0 (NO in S16), that is, when the first control value C1 is smaller than the first control value C1past derived in the previous sampling, the second control value C2 is calculated based on the expression: C2=C1−k×(C1past−C1) (S18). In this expression, “k” is a coefficient which is adjusted so that the acceleration response and the deceleration response may be equal to each other when the absolute value |C1past-C1| of the amount of change in the first control value C1 is equal in both acceleration and deceleration. “k” is a positive integer, but is not limited thereto.

The control value determining portion 203 outputs the second control value C2 to the PWM braking signal generating portion 206.

The second control value C2 is used for changing the duty cycle of a PWM braking signal generated by the PWM braking signal generating portion 206.

The PWM braking signal generating portion 206 includes a counter (not shown) configured to count one period of the pulse signal from 0 (zero) to a maximum value, and a comparator (not shown) configured to compare a count value of the counter and the second control value C2. When the second control value C2 is equal to or larger than the count value, the PWM braking signal generating portion 206 sets the voltage level of the pulse signal to Low, and, when the second control value C2 is smaller than the count value, the PWM braking signal generating portion 206 sets the voltage level of the pulse signal to High, to thereby generate a PWM braking signal.

When the voltage level of the PWM braking signal is Low, the electric brake is not put on the motor 101. When the voltage level of the PWM braking signal is High, the electric brake is put on the motor 101. The PWM braking signal generating portion 206 functions as an adjusting unit configured to adjust the amount of current for driving the motor 101 in accordance with the second control value C2.

The CPU 500 outputs the PWM braking signal from the PWM braking signal generating portion 206 to the braking logic circuit 317 of the motor driver 616 (S19).

Now, how to derive the second control value C2 by the control value determining portion 203 will be described below by way of an example where the absolute value of “C1−C1past” is equal in both acceleration and deceleration. The duty cycles of the PWM braking signals controlled by the first control value C1 and the second control value C2 are placed between parentheses after C1 and C2, respectively.

First, a description will be provided of an example where the absolute value |C1past−C1| of the amount of change in the first control value C1 at the time of acceleration is 1.

The first control value C1 input from the PID controller 202 to the control value determining portion 203 is C1 (51%). C1 (51%) represents a first control value for setting the duty cycle of the PWM signal to 51%.

The control value determining portion 203 generates a PWM braking signal with a duty cycle of 49% in order to set the duty cycle of the PWM signal to 51%. The first control value C1past, which is derived in the previous sampling of the first control value C1 (51%), is C1past (50%).

The CPU 500 causes the control value determining portion 203 to determine whether “C1−C1past” is 0 (zero) or more.

C1(51%)−C1past(50%)=51−50=1≧0

The above calculation finds that C1−C1past is 0 or more, and hence the first control value C1 (51%) is set as the second control value C2 (51%).

In other words, the duty cycle of the PWM signal is increased from 50% to 51% by 1%, which is the same as the absolute value of 1 of the amount of change in the first control value C1, to thereby accelerate the motor 101. Specifically, the control value determining portion 203 generates a PWM braking signal with a duty cycle of 49% in accordance with the second control value C2 (51%). In other words, the duty cycle of the PWM braking signal is decreased from 50% to 49% by 1%, which is the same as the absolute value of 1 of the amount of change in the first control value C1, to thereby accelerate the motor 101.

Next, a description will be provided of an example where the absolute value |C1past−C1| of the amount of change in the first control value C1 at the time of deceleration is 1.

The first control value C1 input from the PID controller 202 to the control value determining portion 203 is C1 (50%). The first control value C1past, which is derived in the previous sampling of the first control value C1 (50%), is C1past (51%).

The CPU 500 causes the control value determining portion 203 to determine whether “C1−C1past” is 0 (zero) or more.

C1(50%)−C1past(51%)=50−51=−1<0

The above calculation finds that “C1−C1past” is smaller than 0, and hence the second control value C2 is calculated based on the expression: C2=C1−k×(C1past−C1). In this case, k=2.

C1−k×(C1past−C1)=50−2×(51−50)=48

From the above calculation, a second control value C2 (48%) is calculated. The second control value C2 (48%) is smaller than the first control value C1 (50%).

In other words, the duty cycle of the PWM signal is decreased from 51% to 48% by 3%, which is larger than the absolute value of 1 of the amount of change in the first control value C1, to thereby decelerate the motor 101. Specifically, the control value determining portion 203 generates a PWM braking signal with a duty cycle of 52% in accordance with the second control value C2 (48%). In other words, the duty cycle of the PWM braking signal is increased from 49% to 52% by 3%, which is larger than the absolute value of 1 of the amount of change in the first control value C1, to thereby decelerate the motor 101.

In this way, even when the absolute value |C1past−C1| of the amount of change in the first control value C1 is equal in both acceleration and deceleration, the amount of change in control value at the time of deceleration (in this example, the decrease amount of 3%) can be set larger than the amount of change in control value at the time of acceleration (in this example, the increase amount of 1%). Thus, the deceleration response can be improved.

The hysteresis comparator 304 of the motor driver 616 converts the voltage generated by the Hall element 303 into a voltage signal H (Ha, Hb, Hc) indicating the position of the rotor 302. The hysteresis comparator 304 outputs the voltage signal H to the switch logic circuit 305.

Based on the voltage signal H of the hysteresis comparator 304, the switch logic circuit 305 selects the coil 301a, 301b, or 301c through which a current is caused to flow, and generates a switching pattern for causing a current to flow through the selected coil 301.

Based on the switching pattern, the switch logic circuit 305 transmits signals to the AND circuits 315a, 315b, and 315c and the braking logic circuit 317.

The switch logic circuit 305 inputs pattern signals for the FETs 313a, 313b, and 313c to the braking logic circuit 317 without any change.

The switch logic circuit 305 inputs the pattern signals for the FETs 314a, 314b, and 314c to the AND circuits 315a, 315b, and 315c, respectively. The AND circuits 315a, 315b, and 315c respectively output, to the braking logic circuit 317, signals of the logical AND of the pattern signals for the FETs 314a, 314b, and 314c (switching pattern) output from the switch logic circuit 305 and the PWM signal output from the PWM signal generating portion 204.

Further, the CPU 500 outputs a PWM braking signal from the PWM braking signal generating portion 206 to the braking logic circuit 317. The braking logic circuit 317 switches the operation of the switch logic circuit 305 between the operation of switching the coil current and the phase-to-phase short circuit operation.

When the PWM braking signal is ON (voltage level is High), the braking logic circuit 317 turns OFF the FETs 314a, 314b, and 314c and turns ON the FETs 313a, 313b, and 313c regardless of the pattern of the switch logic circuit 305. When the PWM braking signal is OFF (voltage level is Low), the braking logic circuit 317 outputs the switch signals a−, b−, and c− and the switch signals a+, b+, and c+ based on the switching pattern input from the switch logic circuit 305. The switch signals a−, b−, and c− are input to the FETs 313a, 313b, and 313c. The switch signals a+, b+, and c+ are input to the FETs 314a, 314b, and 314c.

By switching the FETs 313 and the FETs 314 based on the switch signals, the current to be caused to flow through the coil 301 is switched in accordance with the switching pattern of the switch logic circuit 305, to thereby rotate the motor 101.

In this way, the current to be caused to flow through the coil 301a, 301b, or 301c is switched in accordance with the position of the rotor 302 (the position of the magnet), to thereby rotate the motor 101. Further, the amount of current can be controlled based on the PWM braking signal generated by the PWM braking signal generating portion 206, and hence the motor 101 rotates the drum shaft 11 constantly at a target speed corresponding to the pulse count value output from the host CPU 400.

Returning to the flowchart of FIG. 14, the CPU 500 determines whether or not a stop command has been received from the host CPU 400 (S20). When the stop command has not been received from the host CPU 400 (NO in S20), the CPU 500 repeats the steps of S13 to S19 to control the rotation speed of the motor 101. When the stop command has been received from the host CPU 400 (YES in S20), the CPU 500 stops the control calculation, and turns OFF the ENB signal of the ENB signal generating portion 205 (S21). The ENB signal is input to the switch logic circuit 305 from the ENB signal generating portion 205 of the CPU 500. When the ENB signal is OFF, the switch logic circuit 305 has a switching pattern to turn OFF the flow of all the currents to the coils 301.

According to the second embodiment, the deceleration response can be improved to widen the control bandwidth.

According to the second embodiment, the deceleration response can be improved without adding any friction member, and the deceleration response equivalent in performance to the acceleration response can be obtained. Besides, there is no influence on the control value of the PID controller, and hence the PWM duty can be converged on a value corresponding to a target speed so that the actual speed may be stable at the target speed.

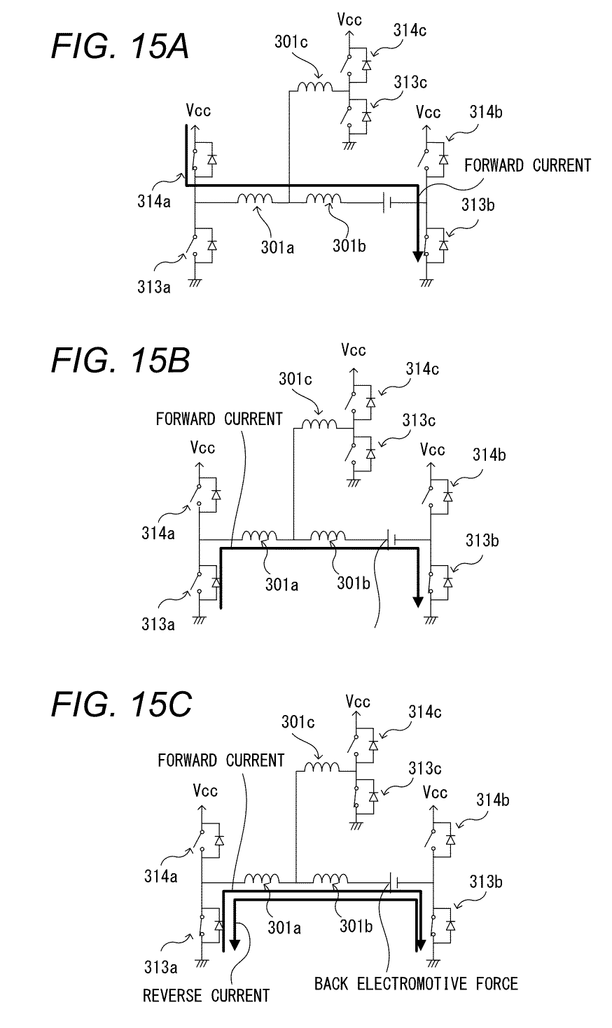

FIGS. 15A to 15C are diagrams illustrating the currents flowing through the coils 301 of the motor 101. Referring to FIGS. 15A to 15C, a description will be provided of the difference between the case of controlling the amount of current by turning OFF the PWM signal and the case of controlling the amount of current by electric braking based on a PWM braking signal.

FIG. 15A is a circuit diagram in which the PWM signal is ON in the switching pattern of causing a forward current to flow from the coil 301a to the coil 301b. The FET 314a and the FET 313b are turned ON. A voltage Vcc is applied to the FET 314a, the coil 301a, the coil 301b, and the FET 313b.

FIG. 15B is a circuit diagram in which the PWM signal is OFF. The FET 314a is turned OFF. The coils 301a and 301b have accumulated energy, and hence, even when the FET 314a is turned OFF, the forward current continues to flow via a parasitic diode of the FET 313a. After the energy accumulated in the coils is consumed, the coil current becomes 0 A (zero amperes).

FIG. 15C is a circuit diagram in which a phase-to-phase short circuit is caused by a PWM braking signal. The FET 314a is turned OFF, and the FET 313a is turned ON. Energy accumulated in the coils 301a and 301b is consumed by the same forward current as that in the case where the PWM signal is OFF. However, when the coil current becomes 0 A, a reverse current starts to flow via the FET 313a due to the back electromotive voltage. This reverse current generates negative torque and acts as a brake.

In other words, according to the second embodiment, when the speed difference is small, the speed can be controlled based on the amount of change in control value so as to obtain the same response to both acceleration and deceleration. Further, when a large positive speed difference, for example, a rising overshoot occurs, a larger braking force can be generated by electric braking.

Note that, in the first and second embodiments of the present invention, the control value determining portion 203 determines whether or not the first control value C1 has decreased based on the difference between the first control value C1 and the first control value C1past derived in the previous sampling. However, the present invention is not limited thereto. The control value determining portion 203 may determine whether or not the first control value C1 has decreased based on the ratio of the first control value C1 to the first control value C1past derived in the previous sampling.

In other words, the control value determining portion 203 may determine whether or not “(first control value C1)/(first control value C1past in the previous sampling)≧1” is established. When “(first control value C1)/(first control value C1past in the previous sampling)≧1” is established, the first control value C1 is set as the second control value C2. When “(first control value C1)/(first control value C1past in the previous sampling)≧1” is not established, a second control value C2 smaller than the first control value C1 may be obtained. In order to obtain the second control value C2, the storage device may store an array (lookup table) for obtaining the second control value based on the first control value C1 and the ratio of the first control value C1 to the first control value C1past derived in the previous sampling.

In the first and second embodiments, the control value determining portion 203 derives the second control value C2 based on the magnitude relation between the first control value C1 and the first control value C1past derived in the previous sampling. However, the present invention is not limited thereto. The first control value C1 may be compared with a first control value derived at least two samplings ago. Alternatively, the first control value C1 may be compared with an average value of a plurality of previous sampling data.

According to the embodiments, the deceleration response can be improved so that the rotation speed of the motor may be sufficiently stable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-086522, filed Apr. 5, 2012, which is hereby incorporated by reference herein in its entirety.

What is claimed is:

1. A motor controlling apparatus, comprising:
a detector configured to detect a rotation speed of a rotary member rotated by a motor;
a first determining portion configured to determine a first control value based on a difference between a target speed and the rotation speed;
a second determining portion configured to determine a second control value based on an amount of change in the first control value; and
a motor controlling portion configured to control the motor based on the second control value.

2. A motor controlling apparatus according to claim 1, wherein the detector detects the rotation speed of a rotary shaft of the rotary member.

3. A motor controlling apparatus according to claim 1, wherein the second determining portion determines the second control value by adjusting the first control value based on the amount of change in the first control value, and wherein, in a case that the amount of change in the first control value is smaller than a predetermined value, the second control value is smaller than the first control value.

4. A motor controlling apparatus according to claim 1, wherein the motor controlling portion controls an amount of current for driving the motor.

5. A motor controlling apparatus according to claim 1, wherein the second determining portion samples the first control value once every predetermined period,
and wherein, in a case that the first control value is smaller than a previously-sampled first control value, the second control value is smaller than the first control value.

6. A motor controlling apparatus according to claim 5, wherein, in a case that the first control value is bigger than the previously-sampled first control value, the second determining portion sets the first control value to the second control value.

7. A motor controlling apparatus according to claim 1, wherein the motor controlling portion generates a pulse-width modulated signal in accordance with the second control value.

8. A motor controlling apparatus according to claim 7, wherein the motor controlling apparatus drives the motor in accordance with the pulse-width modulated signal generated by the motor controlling portion.

9. A motor controlling apparatus according to claim 7, wherein the motor controlling apparatus puts an electric brake on the motor in accordance with the pulse-width modulated signal generated by the motor controlling portion.

10. A motor controlling apparatus, comprising:
a detector configured to detect a rotation speed of a motor configured to rotate a rotary member;
a first determining portion configured to determine a first control value based on a difference between a target speed and the rotation speed;
a second determining portion configured to determine a second control value based on an amount of change in the first control value; and
a motor controlling portion configured to control the motor based on the second control value.

11. A motor controlling apparatus according to claim 10, wherein the detector detects the rotation speed of a rotary shaft of the motor.

12. A motor controlling apparatus according to claim 10, wherein the second determining portion determines the second control value by adjusting the first control value based on the amount of change in the first control value, and wherein, in a case that the amount of change in the first control value is smaller than a predetermined value, the second control value is smaller than the first control value.

13. A motor controlling apparatus according to claim 10, wherein the motor controlling portion controls an amount of current for driving the motor.

14. A motor controlling apparatus according to claim 10, wherein the second determining portion samples the first control value once every predetermined period, and, wherein, in a case that the first control value is smaller than a previously-sampled first control value, the second control value is smaller than the first control value.

15. A motor controlling apparatus according to claim 14, wherein, when in a case that the first control value is bigger than the previously-sampled first control value, the second determining portion sets the first control value to the second control value.

16. A motor controlling apparatus according to claim 10, wherein the motor controlling portion generates a pulse-width modulated signal in accordance with the second control value.

17. A motor controlling apparatus according to claim 16, wherein the motor controlling apparatus drives the motor in accordance with the pulse-width modulated signal generated by the motor controlling portion.

18. A motor controlling apparatus according to claim 16, wherein the motor controlling apparatus puts an electric brake on the motor in accordance with the pulse-width modulated signal generated by the motor controlling portion.
